(19) United States
(12) Patent Application Publication
(10) Pub. No.: US 2010/0290777 A1
(43) Pub. Date: Nov. 18, 2010

(54) Apparatus For Driving Micro Shutter And Aperture

(76) Inventors: Yi Jung Chen, Yunlin (TW); Tsung Kai, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/464,881

(22) Filed: May 13, 2009

(51) Int. Cl. G03B 9/10

(52) U.S. Cl. 396/463

(57) ABSTRACT

An apparatus for driving micro shutter and aperture is provided, including a permanent magnet, a coil set, an aperture blade, a curve handle, and a base. The coil set is fixed to the base. The permanent magnet is located between the coils of the coil set. The curve handle is installed with the permanent magnet. The curve handle is linked to the aperture blade. When the current runs through the coil set, the generated magnetic force will exert a reaction force on the permanent magnet. The reaction force will generate a torque to rotate the magnet. With the curve handle linked to the aperture blade, the linkage movement can achieve the object of driving the shutter and the aperture

### FIELD OF THE INVENTION

The present invention generally relates to a shutter and aperture driving apparatus, and more specifically to an apparatus for driving shutter and aperture of handheld devices.

### BACKGROUND OF THE INVENTION

As the trend of installing optical camera modules on mobile phones, GPS or other handheld device gains popularity, more and more users use handheld devices for digital recording. The market demands on the quality of the camera modules also move towards the high quality and miniaturization. The shutter of the conventional optical camera module is either mechanical or electromagnetic valve based. The electromagnetic valve is gaining popularity over the mechanical type because of the quick response time. However, the electromagnetic type still has room for improvement in the area of size, response time and durability.

### SUMMARY OF THE INVENTION

The present invention has been made to overcome the above-mentioned drawback of conventional shutter driving device. The primary object of the present invention is to provide an apparatus for driving micro shutter, including a permanent magnet, a coil set, an aperture blade, a curve handle, and a base. The curve handle is linked to the aperture blade. The curve handle is installed with the permanent magnet. The permanent magnet is located between the coils of the coil set. The coil set is fixed to the base. When the current runs through the coil set, the generated magnetic force will exert a reaction force on the permanent magnet. The reaction force will generate a torque to rotate the magnet. With the curve handle linked to the aperture blade, the linkage movement can achieve the object of driving the shutter and the aperture.

The present invention uses a voice coil motor because the voice coil motor sonic motor has the advantages of short travel range, quick response time, highly linear force exertion proportional to the current and the zero-delay. Therefore, the present invention can improve the restrictions of the conventional technique.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the structure of the present invention; and

FIG. 2 shows a schematic view of the operational movement of the present invention.

### DETAILED DESCRIPTION OF THE PREFERRED EMBODIMENTS

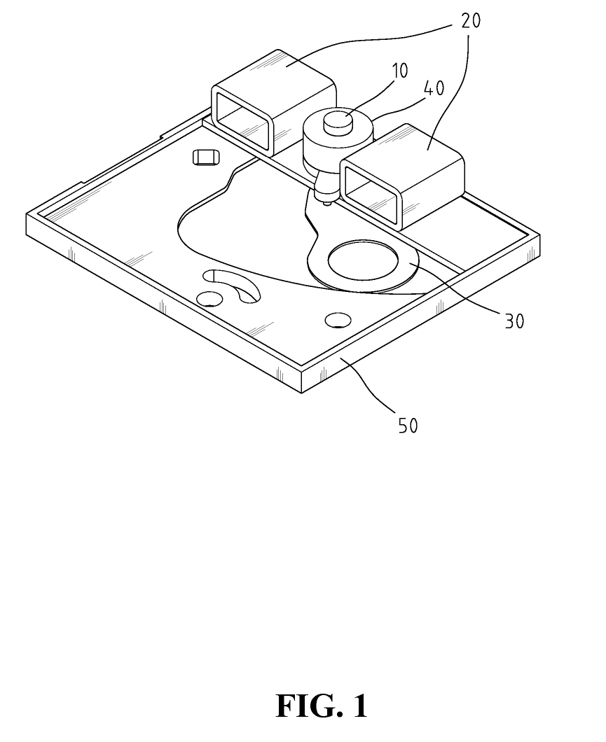

FIG. 1 shows a schematic view of the structure of the present invention. As shown in FIG. 1, an apparatus for driving micro shutter and aperture of the present invention includes a permanent magnet 10, a coil set 20, a aperture blade 30, a curve handle 40 and a base 50. Coil set 20 includes two coils, and is fixed to base 50. Permanent magnet 10 is located between the two coils of coil set 20. Curve handle 40 is fixed to permanent magnet 10. Aperture blade 30 is linked to one end of curve handle 40.

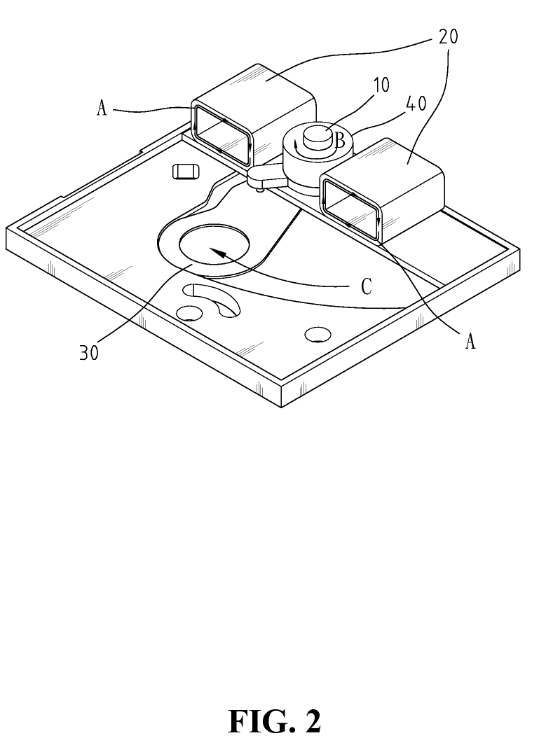

FIG. 2 shows a schematic view of the operational movement of the present invention. As shown in FIG. 2, when the current runs through coil set 20 with the direction A, the current will generate a magnetic force within the effective magnetic field of permanent magnet 10. According to the action and reaction theory, the coils under the action force will generate a reaction force to permanent magnet 10 so that permanent magnet 10 will rotate along the direction B. Because of the rotation of permanent magnet 10, curve handle 40 will also move so that aperture blade 30 will rotate along direction C.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for driving micro shutter and aperture, comprising:
a base;
a coil set, further comprising two coils, said coils being fixed to said base;
a permanent magnet, located between said two coils of said coil set;
a curve handle, fixed to said permanent magnet; and
an aperture blade, linked to one end of said curve handle;
wherein a current running through said coil set along a direction, said current generating a magnetic force to exert a reaction force to said permanent magnet so as to make said permanent magnet rotate, which causing said curve handle to move, and resulting in said aperture blade to rotate along a direction.
